(19) United States
(12) Patent Application Publication
(10) Pub. No.: US 2014/0081709 A1
(43) Pub. Date: Mar. 20, 2014

(54) SYSTEM AND METHOD FOR CONDUCTING AN ONLINE, ANONYMOUS, UNBIASED POLL AND ASSOCIATED STATISTICAL PRESENTATION

(71) Applicant: Paul Palmer, East Sussex (GB)

(72) Inventor: Paul Palmer, East Sussex (GB)

(21) Appl. No.: 14/031,084

(22) Filed: Sep. 19, 2013

(30) Foreign Application Priority Data
Sep. 20, 2012 (GB) 1216797.9

(51) Int. Cl. G06Q 30/02

(52) U.S. Cl. CPC G06Q 30/0203
USPC 705/7.32

(57) ABSTRACT

A system and method for conducting an online poll by providing a website upon which a visitor to the website can post a question or statement accompanied by one or more pre-determined possible responses to the question or statement. A subsequent visitor to the website is able to view the question or statement and select one or more responses. Preferably, questions or statements posed may only be grouped or searched by a visitor to the website using categories of data for which the visitor to the website has provided information. The subsequent visitor is only able to view the results of the poll once he or she has selected a response. Preferably, responses selected to a question or statement may only be grouped or searched by a visitor to the website using categories of data for which the visitor to the website has provided information.

### CROSS REFERENCE TO RELATED APPLICATION

This application claims the benefit of and takes priority from United Kingdom Provisional Application No. GB1216797.9 filed on Sep. 20, 2012, the contents of which are hereby incorporated by reference.

### BACKGROUND OF THE INVENTION

1. Field of the Invention

The instant invention relates to methods for conducting online polls, and more particularly to a system and method for conducting online polls which are honest and unbiased.

2. Description of the Related Art

Various online polling systems exist. However, they are often set up in such a way that a voter is swayed one way or another. For example, they may be associated with a discussion regarding the topic surrounding the question posed. This is especially the case for polls which are run in association with news stories or topical website editorials.

### SUMMARY OF THE INVENTION

The instant system and method, as illustrated herein, is clearly not anticipated, rendered obvious, or even present in any of the prior art mechanisms, either alone or in any combination thereof. The system and method includes a means for conducting an online poll free of bias while allowing a user to remain anonymous. Thus the several embodiments of the instant apparatus are illustrated herein.

According to one aspect of the instant invention, there is provided a method for conducting an online poll, the method comprising providing a website upon which a visitor to the website can post a question or statement accompanied by one or more pre-determined possible responses to the question or statement, wherein

(i) a subsequent visitor to the website is able to view the question or statement and select one or more responses;
(ii) the subsequent visitor is only able to view the results of the poll once they have selected a response;
(iii) once the subsequent visitor has selected a response they are granted access to a forum for discussing the question;
(iv) once the subsequent visitor has viewed the results of the poll and/or taken part in or viewed comments made in the forum they are permitted to change their response; and
(v) a change in response is visible in the results of the poll.

Preferably, only two possible responses are permitted.

Preferably, the possible responses are yes or no.

Preferably, the possible responses are agree or disagree.

Preferably, the possible responses are like or dislike.

Preferably, the subsequent visitor must provide a reason in order to change their response. Preferably, a change in response is provided in a different color in the results of the poll.

Preferably, the results of the poll are represented graphically.

Preferably, a change in response is represented in a different color as a fraction of the corrected response.

Preferably, a visitor to the website is able to choose how the results of the poll are displayed.

Preferably, a visitor to the website must complete a registration process in order to post a question or statement.

Preferably, a visitor to the website must complete a registration process in order to select a response to a question or statement.

Preferably, a visitor to the website must post a question or statement as part of the registration process.

Preferably, a visitor to the website must select a response to a question or statement as part of the registration process.

These requirements mean that the website is able to encourage active participation by its visitors in order to improve the volume and diversity of questions or statements posted and responses selected.

Preferably, the registration process asks for the submission of data useful for filtering questions or statements posed, and/or responses selected.

Preferably, the data comprises demographic information.

Preferably, the data comprises username, password, email address, gender, date of birth, post/zip code, country, religion, nick-name, likes, dislikes, occupation, and/or education.

Preferably, once a visitor to the website has completed a registration process, they are provided with a personal page upon which information about the questions or statements they have posted is displayed.

Preferably, the personal page is a user definable bespoke dashboard displaying data that is of interest solely to the visitor.

Preferably, the personal page displays information about the questions or statements to which the visitor has selected a response.

Preferably, questions or statements posted on the website can be grouped.

Preferably, questions or statements posted on the website can be searched by a visitor to the website.

Preferably, questions or statements posted on the website can be grouped or searched according to a category selected from home life and living, work/business, sport, education, health/wellbeing/medical, motor/automotive, children, animals, hobbies, holidays/hotels/destinations, shopping/retail, entertainment/movies/TV/games, love/sex/romance, religion/belief, politics, weather, IT/computing, literature/arts, and/or food/drink.

Preferably, questions or statements posted on the website can be grouped or searched according to information related to the visitor who posted the question or statement.

Preferably, questions or statements posted on the website can be grouped or searched according to demographic information related to the visitor who posted the question or statement.

Preferably, questions or statements posted on the website can be grouped or searched according to information comprising or forming part of a username, password, email address, gender, date of birth, post/zip code, country, religion, nick-name, likes, dislikes, occupation, and/or education of the visitor who posted the question or statement.

Preferably, questions or statements posted on the website can be grouped or searched according to a category selected from the question or statement with the largest number of hits, the question or statement with the largest number of answers, the question or statement with the largest number of followers, the question or statement with the largest number of comments, and/or the most recently added question or statement.

Preferably, questions or statements posed can only be grouped or searched by a visitor to the website using categories of data for which the visitor to the website has provided information.

Preferably, questions or statements posted on the website can be grouped or searched according to the responses selected.

Preferably, a visitor to the website can mark one or more questions or statements posted by another visitor to the website with a comment.

Preferably, a question or statement posted by a visitor to the website can be marked by another visitor to the website with a comment.

Preferably, the comment is selected from the following responses; “like the post”, “dislike the post”, “excited about the post”, “anxious about the post”, “curious about the post”, “need to know about the post”, and/or “favorite post”.

Preferably, the comment is color coded.

Preferably, the comment is in the form of a flag.

Preferably, if a question or statement is not marked with a comment, it is displayed as having a neutral comment.

Preferably, questions or statements posted on the website can be grouped or searched according to a comment marked against a question or statement.

Preferably, questions or statements posted on the website can be grouped or searched according to the questions or statements viewed by a particular user or to which a particular user has selected a response.

Preferably, a visitor to the website can watch a question or statement and the responses selected thereto.

Preferably, a visitor to the website is able to manipulate data resulting from one or more online polls, for example a group of polls which have been grouped as described herein.

Preferably, said data comprises the result of one or more polls, questions or statements posted, responses selected and/or comments made, preferably after being searched or grouped as described herein.

Preferably, not all features described herein are available to all visitors to the website.

Preferably, a subscription is required to enable a visitor to the website to access one or more preferred features of the instant invention.

Preferably, visitors to the website may only contact each other through a personal page of the website provided to them following a registration process.

Preferably, visitors to the website may only contact each other via one or more standardized comments or responses.

Preferably, visitors to the website are only identifiable to other visitors to the website by their username.

Preferably, the question or statement is not a specific question or statement. For example, the question or statement may preferably comprise an image, uploaded file and/or website link.

Preferably, the question or statement comprises text and/or an image.

Preferably, the question or statement is gender specific.

Preferably, responses selected to a question or statement can be grouped.

Preferably, responses selected to a question or statement can be searched by a visitor to the website.

Preferably, responses selected to a question or statement can be grouped or searched according to information related to the visitor who selected the response.

Preferably, responses selected to a question or statement can be grouped or searched according to demographic information related to the visitor who selected the response.

Preferably, responses selected to a question or statement can be grouped or searched according to information comprising or forming part of a username, password, email address, gender, date of birth, post/zip code, country, religion, nick-name, likes, dislikes, occupation, and/or education of the visitor who selected the response.

Preferably, responses which have been grouped or searched as described herein are displayed separately.

Preferably, responses posted by different genders are displayed separately.

Preferably, responses posted by different age groups and/or geographically located visitors to the website are displayed separately.

Preferably, responses selected to a question or statement can only be grouped or searched by a visitor to the website using categories of data for which the visitor to the website has provided information.

Preferably, there is a time limit for a subsequent visitor to select a response. Preferably, the time limit is set by the visitor who posts a question or statement.

Preferably, once the time limit has expired, the results of the poll are visible to all registered users.

Preferably, the website is provided by one or more hardware elements.

Preferably, the one or more hardware elements comprise a server for outputting instructions to generate a website on a user device.

Preferably, the one or more hardware elements comprise a storage device for storing posted questions or statements and/or selected responses and/or forum entries and/or software for implementing website algorithms.

In one aspect of the instant invention, there is provided a platform for a method as described herein.

Preferably, the platform comprises a website.

Preferably, the platform comprises one or more hardware elements.

Preferably, the one or more hardware elements comprise a server for outputting instructions to generate a website on a user device.

Preferably, the one or more hardware elements comprise a storage device for storing posted questions or statements and/or selected responses and/or forum entries and/or software for implementing website algorithms.

In another aspect of the instant invention, there is provided a method for improving well-being in a subject, the method comprising the use by said subject of a method as described herein.

In another aspect of the instant invention, there is provided a method for reducing anxiety in a subject, the method comprising the use by said subject of a method as described herein.

Also provided by the instant invention is a method for reducing stress in a subject, the method comprising the use by said subject of a method as described herein.

Within this specification embodiments have been described in a way which enables a clear and concise specification to be written, but it is intended and will be appreciated that embodiments may be variously combined or separated without parting from the invention.

There has thus been outlined, rather broadly, the more important features of a system and method for sharing and/or endorsing content in order that the detailed description thereof that follows may be better understood, and in order that the present contribution to the art may be better appreciated. There are additional features of the invention that will be described hereinafter and which will form the subject matter of the claims appended hereto.

In this respect, it is to be understood that the system and method are not limited in its application to the details of construction and to the arrangements of the components set forth in the following description or illustrated in the drawings. The system and method are capable of other embodiments and of being practiced and carried out in various ways. Also, it is to be understood that the phraseology and terminology employed herein are for the purpose of description and should not be regarded as limiting.

These together with other objects of the instant system and method, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates an exemplary system for implementing an embodiment of the instant invention.

FIG. 2 illustrates a flow chart of an exemplary process for creating a user account to use with the instant invention.

FIG. 3 illustrates a flow chart of an exemplary process for posting a question or statement in an embodiment of the instant invention.

FIG. 4 illustrates a flow chart of an exemplary process for responding to a poll.

### DETAILED DESCRIPTION OF THE PREFERRED EMBODIMENT

### Overview

The instant invention provides an online application that conducts online polls. The method comprises providing a website upon which a visitor to the website can post a question or statement accompanied by one or more pre-determined possible responses to the question or statement. A subsequent visitor to the website is able to view the question or statement and select one or more responses. The subsequent visitor is only able to view the results of the poll once he or she has selected a response. Once the subsequent visitor has selected a response, he or she is then granted access to a forum for discussing the question. Once the subsequent visitor has viewed the results of the poll and taken part in or viewed comments made in the forum, he or she is then permitted to change his or her response. Any change in response becomes visible in the results of the poll.

### Website/Hardware Elements

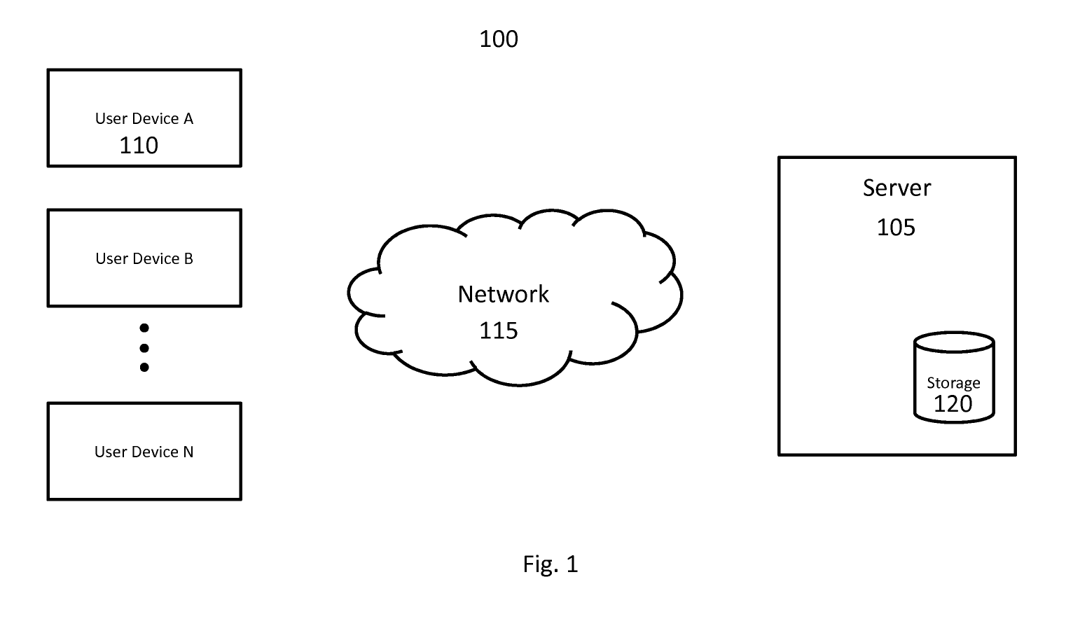

FIG. 1 shows an exemplary system 100 for implementing an embodiment of the instant invention. A system 100 will typically be implemented as a website provided by one or more hardware elements. Preferably, the one or more hardware elements comprise a server 105 hosting a platform accessible by a user device 110. The user device 110 connects to the platform via a network 115, and the user device may be a personal computer, tablet, or mobile device. The one or more hardware elements comprise a storage device 120 for storing posted polls, questions, statements, responses, forum entries, and software necessary for implementing the website. The platform may comprise a website. For example, an embodiment of the invention could be implemented on a Linux server with a MySQL database, Apache http daemon, and a variety of PHP scripts.

### Registration

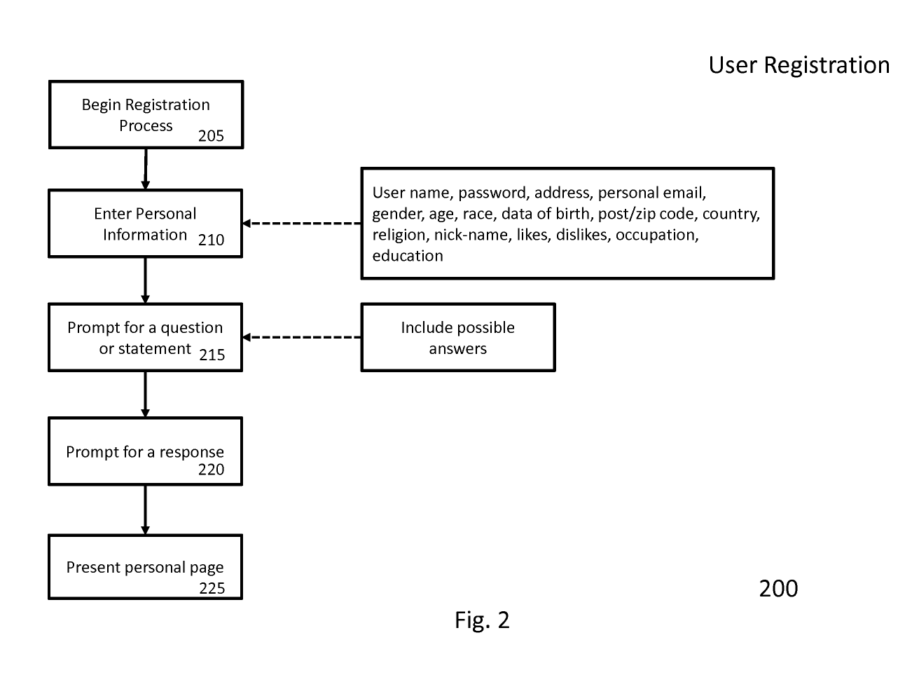

FIG. 2 shows a flow chart of an exemplary process 200 for creating a user account to use with the instant invention. In this embodiment of the instant invention, a visitor to the website must create an account in order to post or view questions or statements. In step 205, a visitor begins the registration process for creating an account. The visitor may log-in with a social network profile, or alternately sign up for an account unique to the particular embodiment. In step 210, the visitor enters his or her personal information, a user name, a password, and privacy settings. The personal information comprises information such as full name, address, personal email, gender, age, race, birth date, postal code, country, religion, nick-name, likes, dislikes, occupation, and education. This information can be useful when visitors want to sort or search for polls and responses made by a subsection of the site population.

In step 215, the visitor must provide a question or statement as part of the registration process. In step 220, the visitor must provide a response to the question or statement. Finally, registration is complete, and in step 225 the user may log in to view their personal page. In alternate embodiments, registration may not be required to post or view questions or statements. In alternate embodiments, registration may only be required to respond to questions or statements. However, the inventors have realized that requiring the posting of a question or statement and a response during registration encourages active participation by visitors, thus improving the volume and diversity of questions or statements posted and responses selected.

Once the visitor has completed the registration process, he or she is provided with a personal page upon which information about the questions or statements they have posted is displayed. Preferably, the personal page is a user-definable bespoke dashboard displaying data that is of interest solely to the visitor. For example, the personal page can display information about the questions or statements to which the visitor has selected a response. The personal page may also allow the visitor to search for or group existing questions and statements.

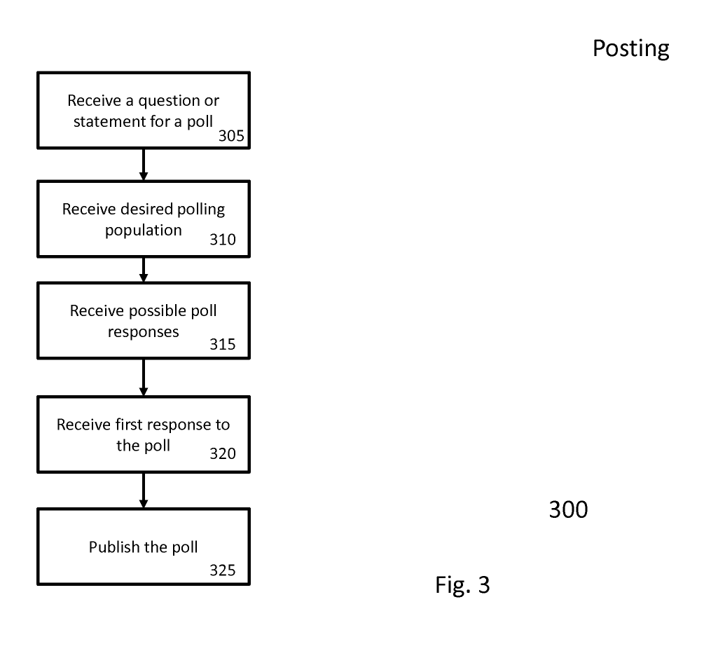

FIG. 3 shows a flow chart of an exemplary process for posting a question or statement in an embodiment of the instant invention. Once a visitor has logged into the website, they may post questions or statements for others to answer. In step 305, the visitor provides a polling question or statement to the website. The question or statement may be a text string, or alternately may comprise an image, uploaded file, or website link. Polls may also be placed into a variety of categories, including home life and living, work/business, sport, education, health/wellbeing/medical, motor/automotive, children, animals, hobbies, holidays/hotels/destinations, shopping/retail, entertainment/movies/TV/games, love/sex/romance, religion/belief, politics, weather, IT/computing, literature/arts, and food/drink.

In step 310, an indication of a desired population to provide responses to the poll is received. For example, a poll could be restricted to those of a certain age or gender. A poll could even take advantage of the extensive personal information compiled during the user registration process to limit the responses to highly specific populations, such as “all those who received high honors at Harvard.”

In step 315, at least two possible responses to the question or statement are received. Typically, these responses will be of a binary nature, such as “Yes/No,” “Like/Dislike,” or “Agree/Disagree.” In alternate embodiments, the poll responses could include longer statements specified by the poll creator, as well as more than two responses. The poll creator cannot view any responses to the poll until step 320, when the poll creator posts the first response. Once the first response is received, in step 325 the poll is published and viewable by other visitors to the web site.

### Viewing/Responding

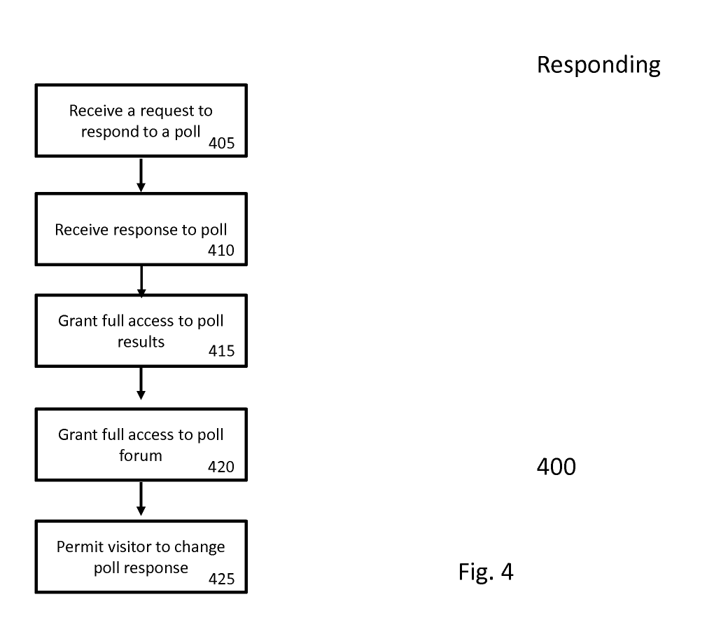

FIG. 4 shows a flow chart of an exemplary process for responding to a poll. As discussed above, visitors to the web site are able to see the questions or statements for all available polls. However, visitors cannot see responses and detailed information about a poll until they have actually responded to that poll. In step 405, an embodiment of the instant invention receives a request to answer an established poll. In step 410, the response is received. In step 415, the visitor is then granted full access to the poll results, and can see all of the poll responses. Additionally, in step 420, the visitor is granted full access to a forum for discussing the results of the poll.

After participating in the discussion, in step 425 the visitor is then given an option to change their poll response. If the visitor wishes to change his or her mind, he or she can change their response to the post. This can be done in the dashboard. A comment relating to the reason will be required, and the post will be viewed by others in a different color as a fraction of the corrected fraction response. This will give flexibility, but also provide full transparency of all entries on site. A series of radio buttons and drop down menus could be used to standardize the questions. This would also guide the user and enable them to feel comfortable with the submission, but also to help searching and grouping of responses and posts. In some embodiments, the visitor must provide a reason to change their response.

In another embodiment of the invention, a poll has an associated time limit set by the poll creator. During the time limit, access to the poll is granted only to visitors who have provided a response. However, once the time limit has expired, the results of the poll are visible to all registered users.

### Grouping/Searching

Once a visitor has full access to the results of a poll, he or she may group, search, and view the responses to the poll in a variety of ways. For example, responses can be grouped or searched according to information related about the visitor who submitted the response, including all of the personal information collected about the visitor during the registration step, such as username, gender, birth date, postal code, country, religion, nick-name, likes, dislikes, occupation, and education. Grouped responses may be displayed on a by-group basis; for example, responses posted by different genders, age groups, or geographic location could be displayed separately.

Visitors may also group and search for polls. For example, a user could search the polls for questions related to a certain band or song. Visitors can also group and search for polls according to the variety of categories discussed above, including by personal information related to either the poll creator or the responding visitors. Additionally, visitors can group or search polls by the number of hits, answers, followers, or comments. Visitors can also group or search polls by the time the poll was submitted, or find polls that have been commented on by a particular user.

In some embodiments, a visitor to the website is able to manipulate data resulting from a group of polls. This data typically comprises the combined results of one or more polls, including the responses selected and comments made.

Once a visitor has selected a particular poll, the results of the poll are presented graphically. Preferably, any changes in response to a poll are represented in a different color as a fraction of the corrected response. If the poll is a video or audio recording, the user may first watch the poll. In some embodiments, the visitor is able to choose how the results of the poll are displayed.

In one embodiment, questions or statements posed can only be grouped or searched by a visitor to the website using categories of data for which the visitor to the website has provided information.

In yet another embodiment, responses selected to a question or statement can only be grouped or searched by a visitor to the website using categories of data for which the visitor to the website has provided information.

### Commenting/Other

Visitors on the website can also comment on polls. Preferably, a visitor to the website can mark one or more questions or statements posted by another visitor to the website with a comment. In some embodiments, the comment may be selected from an enumerated list, including responses such as “like the post,” “dislike the post,” “excited about the post,” “anxious about the post,” “curious about the post,” “need to know about the post,” and “favorite post.” In some embodiments, the comment is color coded, or may be in the form of a flag. If a question is not marked with a comment, it is displayed as having a neutral comment. Just as polls can be grouped or searched by a variety of criteria related to the poll, polls may be grouped or searched according to the comments posted.

In some embodiments, not all of the features described herein are available to all visitors. For example, a subscription may be required to enable a visitor to access one or more preferred features of the instant invention.

The instant invention relies on anonymity to provide truthful, honest, and unbiased responses to all polls. To that end, contact between visitors in the website may be restricted. In some embodiments, visitors may only contact each other through a personal page of the website provided to them following registration. The website may allow communication through a few pre-selected list of standardized comments or responses. Preferably, visitors are only identifiable to other visitors by their username.

In another aspect of the invention, the inventors contemplate that the invention may be used to improve well-being in a subject. Visitors to the website can use the anonymity of polls and responses to get honest answers to honest questions, thus reducing anxiety and stress.

Example embodiments of the instant invention will now be described.

Within this specification embodiments have been described in a way which enables a clear and concise specification to be written, but it is intended and will be appreciated that embodiments may be variously combined or separated without parting from the invention.

Within this specification, the term “subject” means a human. The instant invention relates to methods for conducting online polls via a website.

The instant invention enables unbiased mass consensus on material posted by an individual for obtaining a pure and uninfluenced result, for example for discovery and well-being.

The instant invention ensures anonymity between users and provides a mechanism that forces the user to commit to a view point before viewing other online polls/drops. The methods of the instant invention enable honest opinion without judgment on a matter posted by the user. The methods may be conducted on an international basis and the results can be displayed as a statistic giving the user a ratio between answers or simply “for” and “against”. The instant invention is designed only for positive and constructive results and has a number of design controls to greatly reduce the possibility of abuse. The instant invention is not primarily designed as social media in the sense that the intention is not for the user to build personal relationships with other users; to the contrary, users will only be honest if there is anonymity between users.

In addition, the instant invention provides the user with a platform from which they can obtain a general census to a potentially embarrassing or sensitive subject anonymously. Other users can also benefit from this statement being posted and the data it creates.

The instant invention provides a platform where users can create a forum and a means to develop meaningful data such that the system is able to display independent consensus to a view, statement, question, and so on. The instant invention provides a tool that may be used to shore an argument, allay personal fear or curiosity or at the other end of the spectrum be used as an unbiased tool to form part of a petition or rally to evoke change. The possibilities are endless.

The data created can be used commercially, politically, for education, for expression, and so on. In one example, the data can be used to positively shape the needs of a consumer or user by enabling access to real data that has been submitted at will for the sole purpose of creating the overall view of the masses.

The instant invention provides a platform for individuals to share information and views anonymously in the form of statistical diagrammatical illustrations, comments and an open forum. Users can pose questions or statements, for example comments that support a viewpoint, run a poll, and so on. The options are only limited by the users. The result is a website designed by the user for the user.

In society, pride and embarrassment present barriers when individuals seek answers to more personal questions and in turn these questions are the less likely to receive an honest answer. As a result, a myth or misunderstanding is perpetuated. Some demographics are especially bad at sharing and snobbery can come into play within certain peer groups. In some situations, the barrier may be a religious one or a social barrier that inhibits honest communication.

The instant invention provides answers, trends, polls or general census to questions posed which are obtained in an unbiased way without prejudice and without anyone knowing the identity of the users or their posts. The result is honest data posted by like-minded people for the purpose of discovery, comfort, confidence building or maybe for more commercial or political outcomes, and so on.

The instant invention provides an alternative to manipulated polling stats, biased newspaper conjecture and government cultivated speculation or propaganda.

In particular examples, the instant invention provides:—
(i) a platform to share and empower;
(ii) a confidence building aid;
(iii) a parental aid to share and allay fears;
(iv) an aid to gain a better perspective of others views and interests; and/or
(v) a discovery platform.

Anonymity, credibility, honesty and integrity are values at the center of the instant invention and all users will be required to share the sense of responsibility of the website and continue to up hold these values. Information regarding the control and handling of sensitive data, how it is used and the data protection act is to be made easily available and the site will drive first time users to this information. The home page will enable the user to find content that elaborates on the functionality and purpose of the site giving assurances by illustrating and clearly defining that the site is for the user and that the anonymity exercised by the user can also provide a veil enabling the user to express on mass to a greater audience a collective view. The results are a view which is democratic, pure, uncorrupted and not manipulated.

Since the instant invention relies on the values outlined above, controls and measures are put in place to control the content and the integrity of the site. This will build confidence with the user and therefore open the user to be more expressive and prolific in their use of the site, fuelled by curiosity and the need to get honest answers to questions they previously could not obtain.

The user has to follow a certain process that is uniform for all. All first time users must register and accept the website terms and conditions. They must also acknowledge that they understand the website's position when it comes to data protection and the ethos of the site. They also must verify their registration by submitting their first question or statement (also referred to as a “post”) and answer (also referred to as a “drop”). At this point the user can then view the data relating to the post and upload any supporting data and/or comments on a forum page.

The data is displayed in real time on a user's dashboard. Every time a user provides a response the individuals that are watching the post including the originator will have an illustration on their dash board (an alert). If they wish to they can then view the real time data by means of a graph illustrating the ratios of results to the post.

Further posts by already registered users follow the same process, i.e. they must post their response along with any supporting uploading data and/or comments on the forum page before they are able to view the response data.

All users will have to follow a mandatory registration process. There will be areas to submit both mandatory and non-mandatory personal information. The non-mandatory information is used by the website to enable further demographic filter submissions of posts.

At the point of registration the user can define the level of service they require. For example, the user can enter more email addresses for alerts, favorites, watch lists, change the frequency of the alerts, define the type of alerts they would like by category, and so on. The user can also ask to be kept up to date with posts that have characteristics such as the most hits, the most responses, the most recent, only posts that are posted by a certain demographic, posts that have been posted by users that have posted against the user, and so on. In some examples, for example when a demographic is selected relating to a particular age-group, this can ensure that the content is age appropriate and can be controlled in an adequate fashion.

If the user wishes to change their mind they can change their response to the post. This may occur after the user has gained access to the uploaded data files or open forum. This can be done in their dashboard. A comment relating to the reason for the change will be required and the post will be viewed by others in a different color as a fraction of the corrected fraction response. This will give flexibility but also provide full transparency of all entries on site. A series of radio buttons and drop down menus could be used to standardize the questions. This would also guide the user and enable them to feel comfortable with the submission but also to help searching and grouping of responses and posts.

In some examples of the instant invention, similar posts can be grouped together to further enrich the quality of the data, if required by the user.

For example, individuals who achieved a 2:1 at Cambridge for physics could be grouped with individuals who achieved a 1st at Cambridge for physics, or equally, individuals that achieved a 2:1 at Cambridge for chemistry, and so on. The possibilities are endless and very rewarding.

Further filters could be by demographic information of the users, and so on.

Of particular use in the instant invention is the ability to see the statistical breakdown of responses, posts, users, for example via graphical information together with demographic and generic user information breakdown manipulation, as desired.

The information provided on the website is strictly generic and no personal user information is obtainable or shared.

In preferred examples of the invention, it is possible to search for topics for viewing or for data manipulation. It will be appreciated that any number of categories could be used. Examples include home life and living, work/business, sport, education, health/wellbeing/medical, motor/automotive, children, animals, hobbies, holidays/hotels/destinations, shopping/retail, entertainment/movies/TV/games, love/sex/romance, religion/belief, politics, weather, IT/computing, literature/arts, food/drink, and so on.

For those posts for which a category has not been created, the post will enter a miscellaneous category and engineers will create and move the post into the correct corresponding category. This will mean that grouping is then enabled.

Examples of filters that could be used to further refine searches, increase the accuracy of a post, and so on, include username, password, email address, gender, date of birth, post/zip code, country, accommodation type, religion, nick-name, likes, dislikes, occupation, education, and so on.

Filters can also be used to search for posts by other parameters. For example, the post with the largest number of hits, the post with the largest number of answers, the post with the largest number of followers, the post with the largest number of comments, the most recently added post.

Flags of importance may be used to highlight the perceived importance of the question posed to others. These are color coded and used as part of the search criteria. If a flag is not chosen a green neutral flag is displayed as a default.

Examples of possible flags include, “like the post”, “dislike the post”, “excited about the post”, “anxious about the post”, “curious about the post”, “need to know”, and so on.

A user also has the option to tag posts as favorites, and/or to watch posts.

A user may search for posts by demographic and/or what other users have viewed or posted against.

A user may send a link to a post to a similar demographic.

In preferred examples of the instant invention, users may not directly contact each other outside of their dashboards and standardized responses and retorts are available for the user to use to communicate. Their communication will be posted on the recipient's dashboard and only identifiable by the user's user name.

Examples of standardized statements and responses include, “I respect that post!”, “Gutsy!” “Please view other posts by “USERNAME””, “Have you checked out other statements in Category “*****””, and so on.

There will be a statement to alert all users that content and communication is policed.

Preferred examples of the instant invention include additional functionality. For example, an enhanced version of the instant invention may comprise one or more of the following features:
(i) the ability to link posts together through the use of generated statistics;
(ii) the ability to view statistical data in number format;
(iii) the ability to view and manipulate statistical data by user non-mandatory information;
(iv) the ability to view and manipulate statistical data by demographic;
(v) the ability to view statistical data by entry number chronologically.

Preferably, the statement or question posted is not a specific statement or question. For example, the statement or question may preferably comprise an image, uploaded file and/or website link.

In preferred examples of the instant invention, an image can, therefore, be uploaded as part of a question or statement, for example where a decisive response can be submitted.

It is intended that a standard version of the instant invention will be free to a user. Advertising on the site will be limited and selective. There will be a “Loaded” version where the user will pay an annual subscription to be able to manipulate the data, pin (group) posts together, options on how the data is displayed graphically, extensive filtering options, and so on. It is also intended that there will be an unbranded/white label version of the instant invention that will be available for organizations, broadcasters, organized debates, game shows, reality TV shows, and so on. The unbranded/white label version could also be used by companies and organizations a like to enable them to use and display simplified results to questions or statements specific to their industry to assist in sales and marketing activities.

In some embodiments of the instant invention, a user definable bespoke dashboard displaying data that is of interest solely to the user is provided.

It will also be appreciated that gender specific questions or statements can be posted. The opposite gender can drop against the post to view the results; however their drop will be displayed in a separate display graphically so that the data is not diluted if the originator of the post was interested in conducting a poll and obtaining data surrounded their specific gender and not all gender. The same can be said for age bracketed posts, geographically related posts, and so on.

The post can be “open” for a specific amount of time, if the originator so chooses. There is a countdown graphic which counts down to zero and can be set to hours days or years. Once this time elapses no more drops can be made and the results become visible to all registered users without the requirement to select a response.

A general feedback option enables the user to give predefined feedback on a question or comment by indicating if they like or dislike the results. It is also possible for the user to provide comments somewhere in between, for example such as “feel sad, funny, sick, cool, geeky” and so on. This can be done once they have made their drop and viewed the data.

It should be understood that various changes and modifications to the presently preferred embodiments described herein will be apparent to those skilled in the art. Such changes and modifications can be made without departing from the spirit and scope of the instant invention and without diminishing its attendant advantages. It is therefore intended that such changes and modifications are covered by the appended claims.

What is claimed is:

1. A method for conducting an online poll comprising the steps of:
providing a website by a server system for a visitor to post a question or statement accompanied by one or more pre-determined possible responses to the question or statement;
storing the question or statement accompanied by one or more pre-determined possible response on a storage device;
displaying the question or statement to a subsequent visitor to the website;
selecting one or more responses to the question or statement by the subsequent visitor;
storing the one or more responses selected by the subsequent visitor on the storage device;
displaying the results of the online poll by the server system once one or more responses have been selected;
accessing a forum for discussing the posted question or statement once the subsequent visitor has selected a response;
permitting the subsequent visitor to change the selected response after the subsequent visitor has viewed the results of the poll and/or taken part in or viewed comments made in the forum; and
displaying the change in the selected response.

2. The method according to claim 1, wherein only two possible responses are permitted by the subsequent visitor.

3. The method according to claim 1, wherein the subsequent visitor must provide a reason in order to change their selected response.

4. The method according to claim 1, wherein a change in the response is provided in a different color in the results of the poll.

5. The method according to claim 4, wherein a change in response is represented in a different color as a fraction of the corrected response.

6. The method according to claim 1, wherein a visitor to the website must complete a registration process in order to post a question or statement and/or in order to select a response to a question or statement.

7. A method according to claim 6, wherein a visitor to the website must post a question or statement and/or select a response to a question or statement as part of the registration process.

8. The method according to claim 6, wherein the registration process asks for the submission of data useful for filtering questions or statements posed, and/or responses selected.

9. The method according to claim 1, wherein questions or statements posted on the website and/or responses selected can be grouped and/or searched by a visitor to the website.

10. The method according to claim 1, wherein a visitor to the website can mark one or more questions or statements posted by another visitor to the website with a comment.

11. The method according to claim 1, wherein questions or statements posted on the website and/or responses selected are selected from the group consisting of:
(i) a category selected from home life and living, work/business, sport, education, health/wellbeing/medical, motor/automotive, children, animals, hobbies, holidays/hotels/destinations, shopping/retail, entertainment/movies/TV/games, love/sex/romance, religion/belief, politics, weather, IT/computing, literature/arts, and/or food/drink;
(ii) information related to the visitor who posted the question or statement;
(iii) demographic information related to the visitor who posted the question or statement;
(iv) information comprising or forming part of a username, password, email address, gender, date of birth, post/zip code, country, religion, nick-name, likes, dislikes, occupation, and/or education of the visitor who posted the question or statement;
(v) a category selected from the question or statement with the largest number of hits, the question or statement with the largest number of answers, the question or statement with the largest number of followers, the question or statement with the largest number of comments, and/or the most recently added question or statement;
(vi) the responses selected;
(vii) a comment marked against a question or statement; and/or
(viii) the questions or statements viewed by a particular user or to which a particular user has selected a response.

12. The method according to claim 1, wherein visitors to the website may only contact each other via one or more standardized comments or responses, and/or are only identifiable to other visitors to the website by their username.

13. The method according to claim 1, wherein the website is provided by one or more hardware elements.

14. The method according to claim 13, wherein the one or more hardware elements comprise a server for outputting instructions to generate a website on a user device.

15. The method according to claim 13, wherein the one or more hardware elements comprise a storage device for storing posted questions or statements and/or selected responses and/or forum entries and/or software for implementing website algorithms.

16. A platform for a method according to claim 1.

17. A platform according to claim 16, wherein the platform comprises a website.

18. A platform according to claim 17, wherein the platform comprises one or more hardware elements.

19. A platform according to claim 18, wherein the one or more hardware elements comprise (i) a server for outputting instructions to generate a website on a user device and/or (ii) a storage device for storing posted questions or statements and/or selected responses and/or forum entries and/or software for implementing website algorithms.

20. A method for improving well-being, reducing anxiety and/or reducing stress in a subject, the method comprising the use by said subject of a method according to claim 1.
